(19) United States
(12) Patent Application Publication
(10) Pub. No.: US 2003/0001999 A1
(43) Pub. Date: Jan. 2, 2003

(54) Sealing structure and sealing method of liquid crystal display

(76) Inventors: Jin Mahn Kim, Kyoungki-do (KR); Seung Hee Lee, Kyoungki-do (KR)

Correspondence Address: LADAS & PARRY, 224 SOUTH MICHIGAN AVENUE, SUITE 1200, CHICAGO, IL, 60604, US

(21) Appl. No.: 10/167,323

(22) Filed: Jun. 11, 2002

(30) Foreign Application Priority Data
Jun. 14, 2001 (KR) 2001-33456

(51) Int. Cl. G02F 1/1339

(52) U.S. Cl. 349/139

(57) ABSTRACT

Disclosed are a sealing structure and a sealing method of liquid crystal display having improved adhesive strength of sealant. The disclosed has a sealing structure that a predetermined patterns are formed on opposite sides and on the top portion thereof, transparent lower and upper substrates, whereon alignment layer is applied to control the initial arrangement of liquid crystal molecules, are sealed by sealant with a predetermined distance, wherein a dummy strengthening pattern is formed on the substrate region in contact with the sealant to increase adhesive strength of the sealant.

### BACKGROUND OF THE INVENTION

1. Field of the Invention

The present invention relates to a liquid crystal display and, more particularly, to a sealing structure and a sealing method of liquid crystal display having improved adhesive strength of sealant.

2. Description of the Related Art

As is generally known, a-liquid crystal display has a structure that a pair of transparent substrates is arranged opposite to each other and a liquid crystal layer is interposed between the substrates.

The lower substrate has a structure that a plurality of gate bus lines and data bus lines are arranged in a matrix type to define a unit pixel area. An insulating layer is interposed between the lines to electrically isolate them. A thin film transistor is arranged at the intersection of the lines to operate as a switcher. Pixel electrodes are arranged in each pixel, composed of transparent metal. An alignment layer is applied on the top portion to control initial arrangement of liquid crystal molecules.

The upper substrate has a structure that a black matrix is arranged at the position corresponding to the boundary of adjacent pixels to define unit pixels. Color resin layers are arranged at the position corresponding to each unit pixel of the lower substrate. A common electrode is provided to drive liquid crystals. An overcoating layer may be applied on the black matrix, color resin layer and common electrode to perform planation. An alignment layer is applied on the top portion to control the initial arrangement of liquid crystals.

In the liquid crystal display, the upper and the lower substrates are firmly sealed with a predetermined distance, that is, a cell gap, to interpose the liquid crystal layer between the substrates.

Referring to FIG. 1, a lower substrate lOa and an upper substrate 10b are sealed by performing thermo-compression process in a state that a sealant 18 is applied on the edge of one substrate with a predetermined width. In the drawing, reference codes 11a and 11b are polarizing plates, 12 is a pixel electrode, 13 is a black matrix, 14 is a common electrode and 16 is an alignment layer.

The sealant 18 may be composed of thermosetting resins or UV-setting resins. The thermosetting resins have advantages of material stability, processing stability and convenience in use. The UV-setting resins have disadvantages that it is difficult to treat the material and to satisfy processing requirements, since printing or dispensing applies them. Moreover, the processing margin of cell gap maintenance is not wide due to rapid setting time. Therefore, thermosetting resins are widely used as a sealant.

However, thermosetting resins have different adhesive strength according to the material of adhesive side. That is, thermosetting resins have different adhesive strength with glass, insulating layer including protective layer, overcoating layer and metal layer. There are cases where leakage and substrates separation are generated in a panel comprising upper and lower substrates due to insufficient adhesive strength of thermosetting resins when a liquid crystal injection process is performed. Therefore, it is required to increase adhesive strength of thermosetting resins for improvement of product reliability, especially, in a large screen liquid crystal display.

As shown in FIG. 1, a sealant 18 and an alignment layer 16 are arranged with a predetermined distance to prevent brightness-spots generated by overlap of the sealant 18, alignment layer 16 and liquid crystal layer (not shown). When they are overlapped, fine residuals and gas, generated in the formation of sealant, are mixed in the liquid crystal layer, thereby lowering resistivity of liquid crystals and generating brightness-spots on the screen in the application of voltage.

Therefore, when the sealant 18 and the alignment layer 16 are arranged with a predetermined distance, it is required to increase adhesive strength of the sealant for improvement of product reliability.

Referring to FIG. 2, a method has been proposed that a plurality of moldings 22 are formed in a dot shape on a sealant coating region (SCR) around the display region (DR) of substrate 20 to increase adhesive strength of sealant. According to this method, it is possible to increase adhesive strength of sealant since the moldings 22 increase the adhesive area of sealant.

However, when the position and the size of moldings are not desirably controlled, cell gap is increased in the position overlapped with the spacer or the glass fiber on the inner side of sealant, thereby generating irregularity of brightness on screen. And, the moldings can damage rubbing cloth when the alignment layer is rubbed, thereby generating rubbing defects and scratch. The above-mentioned problems are more frequent in a large screen liquid crystal display.

### SUMMARY OF THE INVENTION

Therefore, the present invention has been proposed to solve the above problems and the object of the present invention is to provide a sealing structure and a sealing method of liquid crystal display having improved adhesive strength of sealant.

In order to accomplish the above objects, the present invention provides a sealing structure that a predetermined patterns are formed on opposite sides and on the top portion thereof, transparent lower and upper substrates, whereon alignment layer is applied to control the initial arrangement of liquid crystal molecules, are sealed by sealant with a predetermined distance, wherein a dummy strengthening pattern is formed on the substrate region in contact with the sealant to increase adhesive strength of the sealant.

And, the present invention provides a sealing method that a predetermined patterns are formed on opposite sides and on the top portion thereof, transparent lower and upper substrates, whereon alignment layer is applied to control the initial arrangement of liquid crystal molecules, are sealed with a predetermined distance by performing thermo-compression process in a state that a sealant is applied on the edge of one substrate, wherein the thermo-compression is performed with a dummy strengthening pattern to increase adhesive strength of sealant on the substrate region in contact with the sealant.

The dummy-strengthening pattern is arranged on one or more of the substrates.

The dummy strengthening pattern comprises an alignment layer to have a width of 1.0˜1.5 mm in a frame shape by etching the alignment layer.

The alignment layer for dummy strengthening pattern is subjected to an alignment treatment as the alignment layer on the display region.

### BRIEF DESCRIPTION OF THE DRAWINGS

The objects and features of the invention may be understood with reference to the following detailed description of an illustrative embodiment of the invention, taken together with the accompanying drawings.

FIG. 1 is a cross-sectional view showing a sealing part in a conventional liquid crystal display.

FIG. 2 is a plan view showing a structure for increasing adhesive strength of sealant according to a conventional method.

FIGS. 3 and 4 are plan view and cross-sectional view showing a sealing structure and a sealing method of liquid crystal display according to the present invention.

FIG. 5 is a graph showing adhesive strength of sealant by the adhesive side.

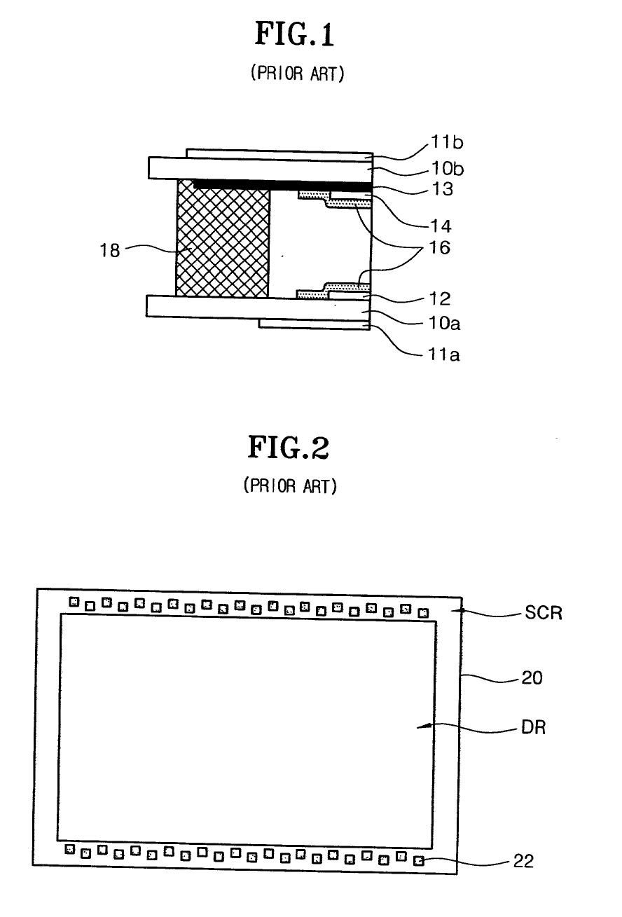

### DETAILED DESCRIPTION OF THE INVENTION

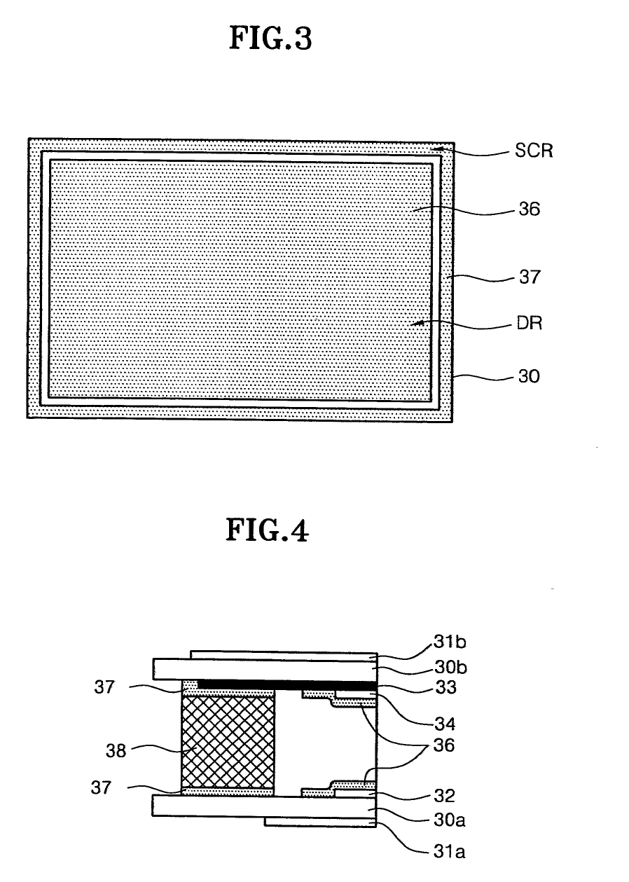

FIGS. 3 and 4 are plan view and cross-sectional view showing a sealing structure and a sealing method of liquid crystal display according to an embodiment of the present invention. In the drawings, a reference code 30 is a substrate, 30a is a lower substrate, 30b is an upper substrate, 31a and 31b are polarizing plates, 32 is a pixel electrode, 33 is a black matrix, 34 is a common electrode, 36 is an alignment layer, 37 is a dummy strengthening pattern comprising an alignment layer, 38 is a sealant, DR is a display region and SCR is a sealant coating region.

Referring to FIGS. 3 and 4, alignment layers 36,37 are applied on the display region DR of the substrate 30 and on surroundings of the display region DR, that is, the sealant-coating region SCR. The alignment layer 36 on the display region DR of substrate is formed to control the initial arrangement of liquid crystal molecules and that on the sealant-coating region SCR (hereinafter, referred to as a dummy strengthening pattern) 37 is additionally formed to increase adhesive strength of sealant.

That is, the dummy strengthening pattern 37 is formed at the same time with the alignment layer 36 on the display region DR by applying alignment layer of poly imides type or poly amide type on the top portion of substrate and performing alignment treatment on the alignment layer by rubbing and then, etching the alignment layer. Here, modifying the etching mask used in pattering the conventional alignment layer without additional processes can form the dummy-strengthening pattern 37.

The dummy-strengthening pattern 37 is formed on one or more of the substrates. Desirably, the dummy-strengthening pattern 37 is formed on both the lower 30a and the upper 30b substrates. The dummy-strengthening pattern 37 is formed on the substrate in contact with the sealant 38 in a line shape, generally in a frame shape. The dummy strengthening pattern 37 has a width of 1.0˜1.5 mm, in contact with the sealant 38 by the width.

According to the structure, the lower 30a and the upper 30b substrates are not directly sealed by the sealant 38 comprising thermosetting resins but by interposing the dummy strengthening pattern 37 additionally formed on the substrate in contact with the sealant 38. The sealant comprising thermosetting resins has improved adhesive strength than bare glass, ITO or overcoating layer with the alignment layer.

Therefore, the sealing structure of the present invention has improved adhesive strength than the conventional one by at least three times since the dummy strengthening pattern, which comprises alignment layer having improved adhesive strength with the thermosetting resins, is additionally formed on the substrate in contact with the sealant 38 comprising thermosetting resins, that is on the sealing region.

And, the dummy-strengthening pattern 37 is subjected to alignment treatment by rubbing as the alignment layer 36 applied on the display region 32. In this case, the dummy-strengthening pattern 37 has a plurality of fine scratches on the surface thereof, thereby increasing the surface area and the chains for liquid crystal alignment are tangled with the sealant. As a result, it is possible to increase adhesive strength of substrates by the sealant.

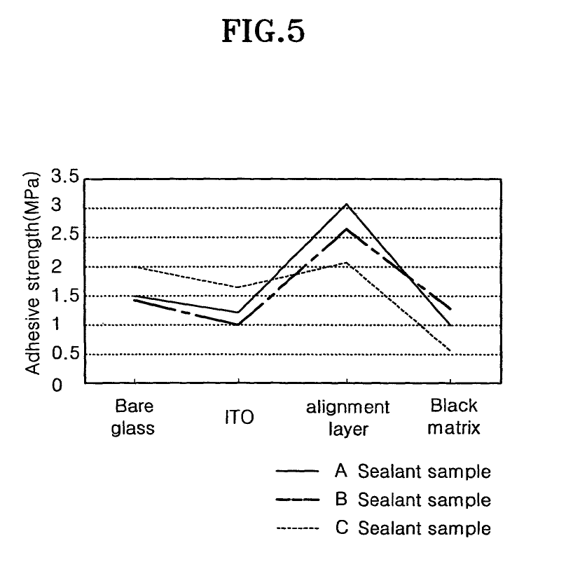

FIG. 5 is a graph showing adhesive strength of sealant by the adhesive side. In the graph, A, B and C sealant samples are thermosetting resins and the components are described in Table 1.

As shown in the graph, all the samples have improved adhesive strength with the alignment layer than that of bare glass, ITO or black matrix. In conclusion, the sealant comprising thermosetting resins has improved adhesive strength with alignment layer.

TABLE 1

| | Sample | | |
|---|---|---|---|
| Composition | A | B | C |
| Solid epoxy resin | 16% | 15% | 15% |
| Liquid epoxy resin | 20.0% | 20% | 20% |
| Liquid epoxy resin | | 10% | |
| (Bis-phenol-F type) | | | |
| Acrylic epoxy resin | 16% | 17% | |
| Silicon epoxy resin | | | 17% |
| Solid amine curative | 4% | | 3% |
| Curing accelerator | 14% | 12% | 14% |
| Coupling agent (silane) | 0.60% | 0.50% | 0.60% |
| Silica (filler) | 3% | 2% | 4% |
| Alumina (filler) | 10% | 9% | 10% |
| Methyl carbitol (solvent) | | 14% | |
| Propylene glycol diaectate (solvent) | 16% | | 16% |
| Etc | 0.40% | 0.50% | 0.4% |

In the Table 1, the sealant has improved adhesive strength with the dummy-strengthening pattern comprising 10 alignment layer materials than with glass in a convention method, thereby firmly sealing substrates.

As described above, according to the present invention, it is possible to increase adhesive strength of sealant between substrates by forming a dummy-strengthening pattern comprising alignment layer materials before applying sealant on the sealing region of substrate. Therefore, it can prevent separation of substrates due to decreased adhesive strength in a liquid crystal display of large size and large screen, thereby improving product reliability and increasing yield.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is

1. A sealing structure that a predetermined patterns are formed on opposite sides and on the top portion thereof, transparent lower and upper substrates, whereon alignment layer is applied to control the initial arrangement of liquid crystal molecules, are sealed by sealant with a predetermined distance,
wherein a dummy-strengthening pattern is formed on the substrate region in contact with the sealant to increase adhesive strength of the sealant.

2. The sealing structure of liquid crystal display according to claim 1, wherein the dummy-strengthening pattern is arranged on one or more of the substrates.

3. The sealing structure of liquid crystal display according to claim 1, wherein the dummy strengthening patter comprises an alignment layer.

4. The sealing structure of liquid crystal display according to claim 3, wherein the dummy strengthening patter is formed in a frame shape.

5. The sealing structure of liquid crystal display according to claim 4, wherein the dummy strengthening pattern has a width of 1.0˜1.5 mm.

6. The sealing structure of liquid crystal display according to claim 3, wherein the alignment layer for dummy strengthening pattern is subjected to alignment treatment.

7. A sealing method that a predetermined patterns are formed on opposite sides and on the top portion thereof, transparent lower and upper substrates, whereon alignment layer is applied to control the initial arrangement of liquid crystal molecules, are sealed with a predetermined distance by performing thermo-compression process in a state that a sealant is applied on the edge of one substrate,
wherein the thermo-compression is performed with a dummy-strengthening pattern to increase adhesive strength of sealant on the substrate region in contact with the sealant.

8. The sealing method of liquid crystal display according to claim 7, wherein the dummy-strengthening pattern is arranged on one or more of the substrates.

9. The sealing method of liquid crystal display according to claim 7, wherein the dummy-strengthening pattern comprises an alignment layer.

10. The sealing method of liquid crystal display according to claim 9, wherein the formation of dummy strengthening pattern comprises the steps of applying alignment layer on the whole substrate, rubbing the alignment layer and etching the rubbed alignment layer.

11. The sealing method of liquid crystal display according to claim 10, wherein the dummy-strengthening pattern is formed in a frame shape.

12. The sealing method of liquid crystal display according to claim 11, wherein the dummy strengthening pattern has a width of 1.0˜1.5 mm.

13. The sealing method of liquid crystal display according to claim 9, wherein the alignment layer f or dummy strengthening pattern is subjected to alignment treatment.
